(19) United States
(12) Patent Application Publication
(10) Pub. No.: US 2023/0298363 A1
(43) Pub. Date: Sep. 21, 2023

(54) SYSTEM AND METHOD FOR DETERMINING LANE WIDTH DATA

(71) Applicant: HERE Global B.V., Eindhoven (NL)

(72) Inventor: Zhenhua ZHANG, Chicago, IL (US)

(21) Appl. No.: 17/698,752

(22) Filed: Mar. 18, 2022

(51) Int. Cl. G06V 20/56; B60W 40/06

(52) U.S. Cl. CPC G06V 20/588; B60W 40/06; B60W 2552/05; B60W 2552/53

(57) ABSTRACT

A system for estimating a lane with of a local road is provided. The system, for example, obtains lane marking data using one or more sensors. Then, the system identifies at least one map link or topology associated with the obtained lane marking data based on map data representative of one or more map links or topologies and determines that the obtained lane marking data is associated with a particular road type based on the identified map link or topology. The system then determines (i) a first lane width dataset including one or more widths of a first category, and (ii) a second lane width dataset based including one or more widths of a second category. A probable lane width then estimated by the system as a function of the first lane width dataset and the second lane width dataset.

### TECHNOLOGICAL FIELD

The present disclosure generally relates to the determination of lane width data and more particularly relates to a system and method to estimate absent lane markings based on vehicle sensor detections.

### BACKGROUND

Lane markings are an important feature for a high-definition map and autonomous vehicle applications. Typically, autonomous vehicles follow the general rules of roads, recognizing traffic signals, lane markings, and detecting crosswalks present on the streets. A clear lane marking regulates the lane boundary of the running autonomous vehicles on the road because the autonomous vehicles work only on well-marked roads that are carefully scanned and mapped in advance. However, many paved roads have faded paint, no painted lanes markings, and signs obscured behind trees and unusual intersections. Painted lane markings are either absent on the road boundary or the road center. Given this, it may be difficult to determine a lane width and estimate a lane boundary.

Therefore, there is a need to have a system and method to efficiently and accurately determine lane width data for the safe transportation of autonomous vehicles and/or other use cases.

### BRIEF SUMMARY OF SOME EXAMPLE EMBODIMENTS

With the advent of autonomous vehicles, efficiently maintaining the quality of lanes markings has never been more important when it comes to safety. These autonomous vehicles rely on various sensors to provide real-time feedback of lanes markings, allowing onboard computers to make safe decisions. Currently, autonomous vehicles assume that lanes markings are clear and, more importantly, are visibly distinct. Lane markings are subject to wear and tear caused by traffic and environmental conditions. The constantly changing traffic and environmental conditions mean it is difficult and time-consuming to monitor the quality of the lane markings. Therefore, poor, and faded lanes markings of paved roads are posing serious problems in the navigation of the vehicles. Specifically, in the case of autonomous vehicles, the problem may become graver if an accurate determination of lane width data and corresponding information is not provided in real-time, leading to delayed navigation decisions and may even cause accidents.

In order to solve the foregoing problem, the present disclosure may provide systems and methods that help to determine lane width data and estimate the lane boundary for autonomous vehicles when lane markings are absent. The methods and systems provide techniques to estimate the absent lane markings based on the vehicle sensor detections.

Various embodiments are provided herein for the determination of lane width data and estimation of the lane boundary when there is no clear lane marking present on the road (e.g., one a local road in a rural area). The determination of lane width data is based on a location categorization method and a lane width categorization and estimation method. The location categorization method isolates the lane marking detections that may have absent lane marking problems. Further, the lane width categorization and estimation method make the best use of the lane marking detections which categorize and estimate the most probable lane width.

Thus, as disclosed herein, the methods and systems describing the determination of lane width data disclosed in various embodiments, utilize location and lane width categorization. Therefore, the methods and systems provide better and more efficient mechanisms to estimate the lane width on the multi-digitized road with one lane in each direction. This is highly advantageous, especially in the case of autonomous vehicles, which benefit from getting accurate, complete, and up-to-date lanes markings in real-time. This further ensures faster decision-making while driving and thus, safer, and more reliable navigation. Further, the methods and systems complement the lane boundary where there is no painted lane marking. Furthermore, the methods and systems efficiently function when there are painted lane markings on the road center as well as when there are no painted lanes markings on the road center.

A system, a method, and a computer programmable product are provided for the determination of lane width data.

In one aspect, a system for determining lane width data is provided. The system, for example, obtains lane marking data using one or more sensors. The system identifies at least one map link or topology associated with the obtained lane marking data based on map data representative of one or more map links or topologies. The system determines whether the obtained lane marking data is associated with a particular road type based on the identified map link or topology. In response to determining that the obtained lane marking data is associated with the particular road type, the system determines (i) a first lane width dataset based on a first subset of the obtained lane marking data that is associated with one or more widths of a first category, and (ii) a second lane width dataset based on a second subset of the obtained lane marking data that is associated with one or more widths of a second category. The system estimates a probable lane width as a function of the first lane width dataset and the second lane width dataset. The system outputs the estimated probable lane width as lane width data.

In additional system embodiments, the particular road type corresponds to a local road.

In additional system embodiments, the particular road type corresponds to a two-lane road having one lane respectively for each direction of travel.

In additional system embodiments, the first category corresponds to widths that are greater than a threshold width, and wherein the second category corresponds to widths that are at or lower than the threshold width.

In additional system embodiments, the first category corresponds to lane markings that respectively define distances between road edges, and wherein the second category corresponds to lane markings that respectively define distances between a road edge and a road centerline.

In additional system embodiments, the function comprises a weighted median associated with the first lane width dataset and the second lane width dataset.

In additional system embodiments, a weight of each of the first lane width dataset and the second lane width dataset is associated with a length of the corresponding lane marking data.

In additional system embodiments, the at least one processor is further configured to extract a key lane marking from the lane marking data based on a width of the key lane marking, such that the width of key lane marking is closest to the lane width data among all lane markings in the lane marking data.

In additional system embodiments, the at least one processor is further configured to extract one or more nearby lane markings in the vicinity of the key lane marking.

In additional system embodiments, the at least one processor is further configured to update a map database based on the key lane marking and the one or more nearby lane markings, such that the update comprises complementing missing lane boundary data of the obtained lane marking data.

In additional system embodiments, the at least one processor is further configured to: remove outlier data from the lane marking data based on a distance associated with the lane marking data and the corresponding identified map link or topology.

In another aspect, a method for determining lane width data is provided. The method comprises obtaining lane marking data using one or more sensors. The method further comprises identifying at least one map link or topology associated with the obtained lane marking data based on map data representative of one or more map links or topologies. Further, the method comprises determining that the obtained lane marking data is associated with a particular road type based on the identified map link or topology. In response to determining that the obtained lane marking data is associated with the particular road type, the method comprises determining (i) a first lane width dataset based on a first subset of the obtained lane marking data that is associated with one or more widths of a first category, and (ii) a second lane width dataset based on a second subset of the obtained lane marking data that is associated with one or more widths of a second category. Further, the method comprises estimating a probable lane width as a function of the first lane width dataset and the second lane width dataset. The method then comprises outputting the estimated probable lane width as lane width data.

In additional method embodiments, the particular road type corresponds to a local road.

In additional method embodiments, the particular road type corresponds to a two-lane road having one lane respectively for each direction of travel.

In additional method embodiments, the first category corresponds to widths that are greater than a threshold width, and wherein the second category corresponds to widths that are at or lower than the threshold width.

In additional method embodiments, the first category corresponds to lane markings that respectively define distances between road edges, and wherein the second category corresponds to lane markings that respectively define distances between a road edge and a road centerline.

In additional method embodiments, the function comprises a weighted median associated with the first lane width dataset and the second lane width dataset.

In additional method embodiments, a weight of each of the first lane width dataset and the second lane width dataset is associated with a length of the corresponding lane marking data.

In additional method embodiments, the method further comprises extracting a key lane marking from the lane marking data based on a width of the key lane marking, such that the width of key lane marking is closest to the lane width data among all lane markings in the lane marking data.

In yet another aspect, a computer program product comprising a non-transitory computer-readable medium having stored thereon computer-executable instructions which when executed by at least one processor, cause the processor to carry out operations for determining lane width data, the operations comprising: obtaining lane marking data using one or more sensors. Further, the operations comprise identifying at least one map link or topology associated with the obtained lane marking data based on map data representative of one or more map links or topologies. Additionally, the operations comprise determining that the obtained lane marking data is associated with a particular road type based on the identified map link or topology. In response to determining that the obtained lane marking data is associated with the particular road type, the operations comprise determining (i) a first lane width dataset based on a first subset of the obtained lane marking data that is associated with one or more widths of a first category, and (ii) a second lane width dataset based on a second subset of the obtained lane marking data that is associated with one or more widths of a second category. Further, the operations comprise estimating a probable lane width as a function of the first lane width dataset and the second lane width dataset. Further, the operations comprise outputting the estimated probable lane width as lane width data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the invention in general terms, reference will now be made to the accompanying drawings, which are not necessarily drawn to scale, and wherein:

FIG. 1 illustrates a block diagram showing an example architecture of a system for determining lane width data, in accordance with one or more example embodiments.

FIG. 2A illustrates an example diagram showing different feature lines on a map for lane markings, in accordance with one or more example embodiments.

FIG. 2B illustrates an exemplary map data record storing data for feature lines shown in FIG. 2A, in accordance with one or more example embodiments.

FIG. 2C illustrates another exemplary map database record storing data for feature lines shown in FIG. 2A, in accordance with one or more example embodiments.

FIG. 2D illustrates an exemplary map database storing data for feature lines shown in FIGS. 2B and 2C, in accordance with one or more example embodiments.

FIG. 3 illustrates an exemplary block diagram of a system for determining lane width data, in accordance with one or more example embodiments.

FIG. 4 illustrates a diagrammatic representation showing the single-digitized multi-lane road, single-digitized one-lane road, multi-digitized road with one lane in each direction, and multi-digitized road with more than two plus lanes in either direction, in accordance with one or more example embodiments.

FIG. 5 illustrates an example diagram showing lane width categorization and estimation, in accordance with one or more example embodiments.

FIG. 6A illustrates an example diagram showing input image of the road before extraction of the key lane marking from the lane marking data, in accordance with one or more example embodiments.

FIG. 6B illustrates an example diagram showing output image of the road after extraction of the key lane marking from the lane marking data based on a width of the key lane marking, in accordance with one or more example embodiments.

FIG. 7 illustrates an example diagram showing removal of outlier data from the lane marking data based on a distance associated with the lane marking data and the corresponding identified map link or topology, in accordance with one or more example embodiments.

FIG. 8A illustrates an example diagram showing determining lane width data without using lane width categorization and with using lane width categorization when there is no painted lane marking on the road center, in accordance with one or more example embodiments.

FIG. 8B illustrates an example diagram showing determining lane width data without using lane width categorization and with using lane width categorization when there is painted lane marking on the road center, in accordance with one or more example embodiments.

FIG. 9 is a flowchart of a method for determining lane width data, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present invention. Thus, the use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer-readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network devices, and/or other computing devices.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for determining lane width data. The lane marking may be associated with boundary lines, also interchangeably referred to as feature line or lane marking data, stored in a map database. The lane marking may be identified based on multiple sources such as sensors, satellite imagery, and ground truth data, and may be dashed, discontinuous, incomplete, and have missing parts. These missing parts need to be complemented to provide enhanced and safe navigation in autonomous, semi-autonomous, and manually driven vehicles.

Various embodiments are provided herein for determining lane width data by combing two key methods that are location categorization method and lane width categorization and estimation method. The location categorization method isolates the lane marking detections that may have absent lane marking problems. Further, the lane width categorization and estimation method make the best use of the lane marking detections which categorize and estimate the most probable lane width.

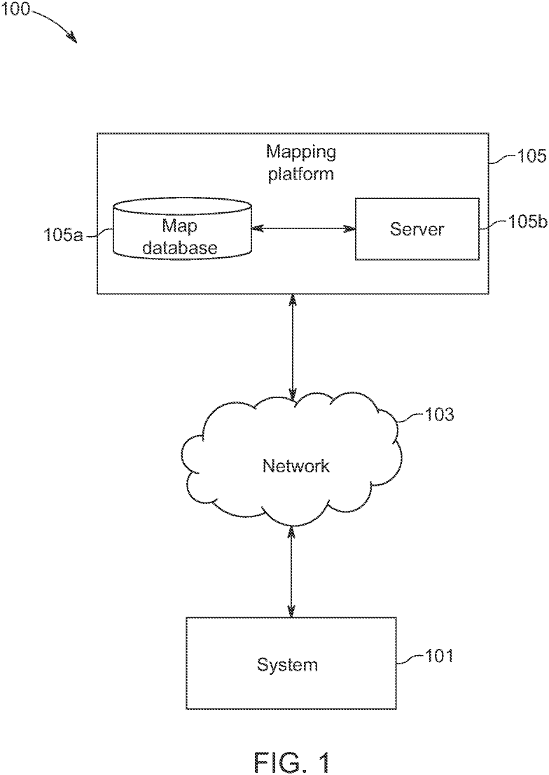

FIG. 1 is an example illustration showing a block diagram 100 showing an example architecture of a system 101 for determining lane width data, in accordance with one or more example embodiments. As illustrated in FIG. 1, the block diagram 100 may comprise the system 101, a network 103, and a mapping platform 105. The mapping platform 105 may further comprise a map database 105a (also referred to as a geographic database 105a) and a server 105b. The components described in the block diagram 100 may be further broken down into more than one component such as one or more sensors or applications in user equipment and/or combined in any suitable arrangement. Further, it is possible that one or more components may be rearranged, changed, added, and/or removed without deviating from the scope of the present disclosure.

In various embodiments, the system 101 may be onboard a vehicle, such as the system 101 may be a navigation system installed in the vehicle for detecting lane marking data and using this data for performing one or more navigation functions. In various embodiments, the vehicle may be an autonomous vehicle, a semiautonomous vehicle, or a manually operated vehicle. In some embodiments, the system 101 may be the server 105b of the mapping platform 105 and therefore may be co-located with or within the mapping platform 105. For example, the system 101 may be embodied as a cloud-based service, a cloud-based application, a cloud-based platform, a remote server-based service, a remote server-based application, a remote server-based platform, or a virtual computing system. In some other embodiments, the system 101 may be an OEM (Original Equipment Manufacturer) cloud. The OEM cloud may be configured to anonymize any data received from the system 101, such as the vehicle, before using the data for further processing, such as before sending the data to the mapping platform 105. In some embodiments, anonymization of data may be done by the mapping platform 105.

In some embodiments, the system 101 may comprise one or more user equipment for example as a part of an in-vehicle navigation system, a navigation app in a mobile device, and the like. In each of such embodiments, the system 101 may be communicatively coupled to the components shown in FIG. 1 to carry out the desired operations and wherever required modifications may be possible within the scope of the present disclosure.

In some example embodiments, the user equipment may be any user-accessible device such as a mobile phone, a smartphone, a portable computer, and the like that are portable in themselves or as a part of another portable/mobile object such as the vehicle. The user equipment may comprise a processor, a memory, and a communication interface. The processor, the memory, and the communication interface may be communicatively coupled to each other. In some example embodiments, the user equipment is associated, coupled, or otherwise integrated with the vehicle, such as an advanced driver assistance system (ADAS), a personal navigation device (PND), a portable navigation device, an infotainment system, and/or other device that may be configured to provide route guidance and navigation-related functions to the user. In such example embodiments, the user equipment comprises processing means such as a central processing unit (CPU), storage means such as on-board read-only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment. For example, the user equipment may be configured to execute and run mobile applications such as a messaging application, a browser application, a navigation application, and the like.

In one embodiment, the user equipment may be directly coupled to the system 101 via the network 103. In another embodiment, the user equipment may be coupled to the system 101 via the OEM cloud and the network 103. For example, the user equipment may be a consumer vehicle (or a part thereof) and may be a beneficiary of the services provided by the system 101. In some example embodiments, the user equipment may serve the dual purpose of a data gatherer and a beneficiary device. For example, the user equipment may be installed in the vehicle and is configured to detect feature lines on links and/or road segments by using image-based sensors installed in the vehicle. The user equipment then sends this detection data to the system 101, which uses unsupervised learning techniques to complete any missing parts in the feature line and generate the feature line for completion.

Further, the system 101 may be communicatively coupled with the mapping platform 105 over the network 103. The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The system 101 may communicate with the mapping platform 105, via the network 103, where the mapping platform 105 may comprise the map database 105a for storing map data, and the processing server 105b for carrying out the processing functions associated with the mapping platform 105. The map database 105a may store node data, road segment data or link data, point of interest (POI) data, road obstacles related data, traffic objects related data, posted signs related data, such as road sign data, sensor data related to permissible driving directions, data about valid paths based on legally permissible road geometries or the like. The map database 105a may also include cartographic data and/or routing data. According to some example embodiments, the road segment data records may be links or segments representing roads, streets, or paths, as may be used in calculating a route or recorded route information for the determination of one or more personalized routes. The node data may be end points corresponding to the respective links or segments of road segment data. For example, the node data may represent data for intersections. The road/ link data and the node data may represent a road network, such as used by vehicles, for example, cars, trucks, buses, motorcycles, and/or other entities.

Optionally, the map database 105a may contain path segment and node data records or other data that may represent pedestrian paths or areas in addition to or instead of the vehicle road record data, for example. The road/link segments and nodes may be associated with attributes, such as geographic coordinates, lane data records, and other navigation-related attributes, as well as POIs, such as fueling stations, hotels, restaurants, museums, stadiums, offices, auto repair shops, buildings, stores, parks, etc. The lane data records may comprise data related to a number of lanes on a particular link/road segment, a number of lanes for a particular link/road segment determined by visual inspection, data about feature lines forming lane markings, and the like. Additionally, the lane data records may comprise legal travel directions (travel directions that the vehicles should follow while traveling on lanes of a particular link/road segment), lane level speed profile (historically derived speed limits for a lane), lane level maneuver pattern (lane change patterns at intersections), and the like.

The map database 105a may include data about the POIs and their respective locations in the POI records. The map database 105a may additionally include data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 105a may include event data (e.g., traffic incidents, construction activities, scheduled events, unscheduled events, etc.) associated with the POI data records or other records of the map database 105a. The map database 105a may additionally include data related to road signs, road obstacles, traffic objects, and the like. The map database may be communicatively coupled to the processing server 105b.

In one embodiment, the map or geographic database 105a may be maintained by a content provider in association with the mapping platform 105 (e.g., a map developer). The map developer may collect geographic data to generate and enhance the geographic database 105a. There may be different ways used by the map developer to collect data. These ways may include obtaining data from other sources, such as municipalities or respective geographic authorities. In addition, the map developer may employ field personnel to travel by vehicle (e.g., vehicles and/or user terminals) along roads throughout the geographic region to observe features and/or record information about them, for example. Such data may form part of ground truth data records stored in the mapping platform 105. In an alternate embodiment, the ground truth data of the ground truth data records may be collected by a ground truth recorder device installed in the ground truth vehicle. As used herein, the ‘ground truth vehicle’ may correspond to a vehicle manually driven by a human for collecting the ground truth data. As used herein, the ground truth recorder device may be a device (comprising memory and processor) to record a ground truth vehicle location (also referred to as ground truth location data) and data about a road object, when the road object is observed, and the road object is applicable on a link in which the ground truth vehicle is currently traveling.

In some embodiments, the map data may be collected by end-user vehicles which use vehicles’ on-board sensors to detect data about various entities such as road objects, lane markings, links, and the like. These end-user vehicles are also referred to as probe vehicles and form an alternate form of data source for map data collection, along with ground truth data. Additionally, data collection mechanisms like remote sensing, such as aerial or satellite photography, may be used to collect the data for the map database 105a.

The map database 105a may be a master geographic database stored in a format that facilitates updating, maintenance, and development. According to some embodiments, the map data in the map database 105a may be stored as a digital map. The digital map may correspond to a high-definition map or a fast map, which is formed based on satellite raster imagery, bitmap imagery, or the like. The satellite rater imagery/bitmap imagery may include map features (such as road/link segments, nodes, feature lines for lane markings, and the like) and attributes associated with the map features. In some embodiments, the map features may have a vector representation form. Additionally, the satellite raster imagery may include three-dimensional (3D) map data that corresponds to 3D map features, which are defined as vectors, voxels, or the like. In these embodiments, the digital map may be divided into map tiles. Each map tile of the digital map may define a geographic region. The geographic region may include one or more link segments, one or more nodes associated with the one or more link segments, and the attributes associated with the one or more link segments. For example, the geographic region may include a ramp road geometry having a main link segment, a ramp link segment, a ramp start location, and attributes associated with the main link segment and the ramp link segment. The main link segment may correspond to freeway, motorway, expressway, highway, and the like. The ramp link segment may correspond to at least one of an exit-ramp or entrance ramp links associated with the main link segment.

In some embodiments, the map database 105a is a master geographic database, or data in the master geographic database may be in an Oracle spatial format or other spatial formats, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end-user navigation devices or systems.

For example, geographic data is compiled (such as into a platform specification format (PSF) format) to organize and/or configure the data for performing navigation-related functions and/or services, such as maneuvering of an autonomous vehicle, route calculation, route guidance, map display, speed calculation, distance and travel time functions, and other functions, by a navigation device, such as by a vehicle or a user terminal, for example. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end-user device developers, may perform compilation on a received geographic database in a delivery format to produce one or more compiled navigation databases.

The processing server 105b may comprise one or more processors configured to process requests received from the system 101. The processor may fetch map data from the map database 105a and transmit the same to the system 101 in a format suitable for use by the system 101. In some example embodiments, as disclosed in conjunction with the various embodiments disclosed herein, the system 101 may be used to generate one or more feature lines associated with lane markings of the map data stored in the map database 105a.

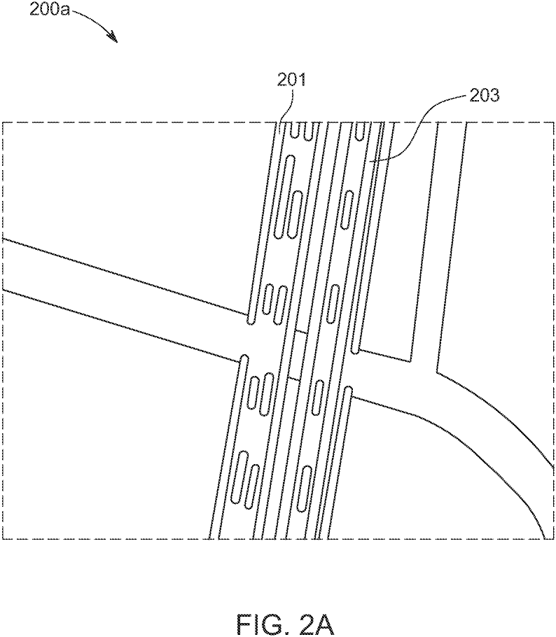

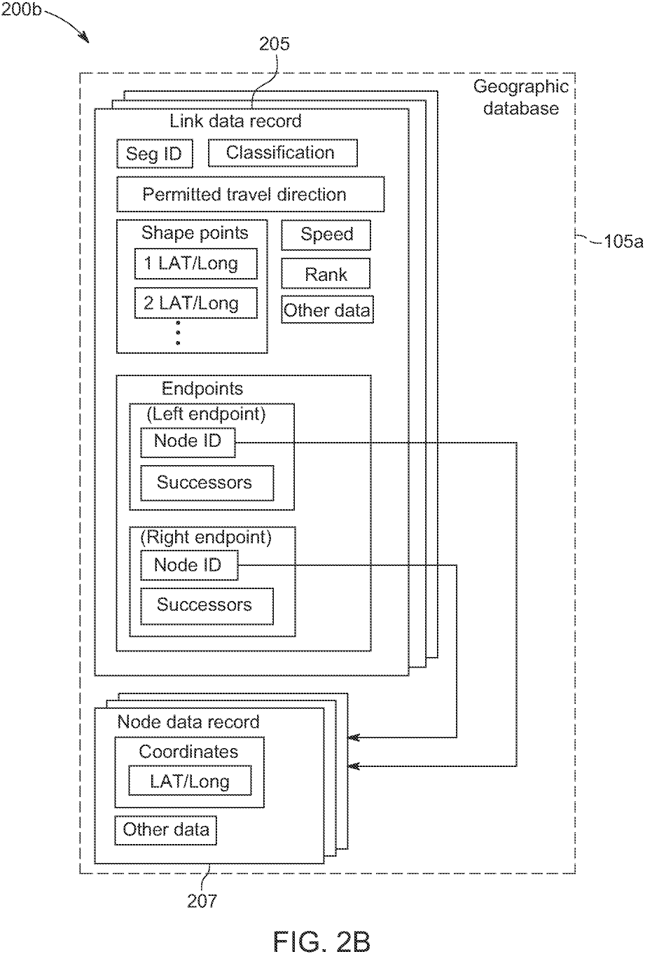

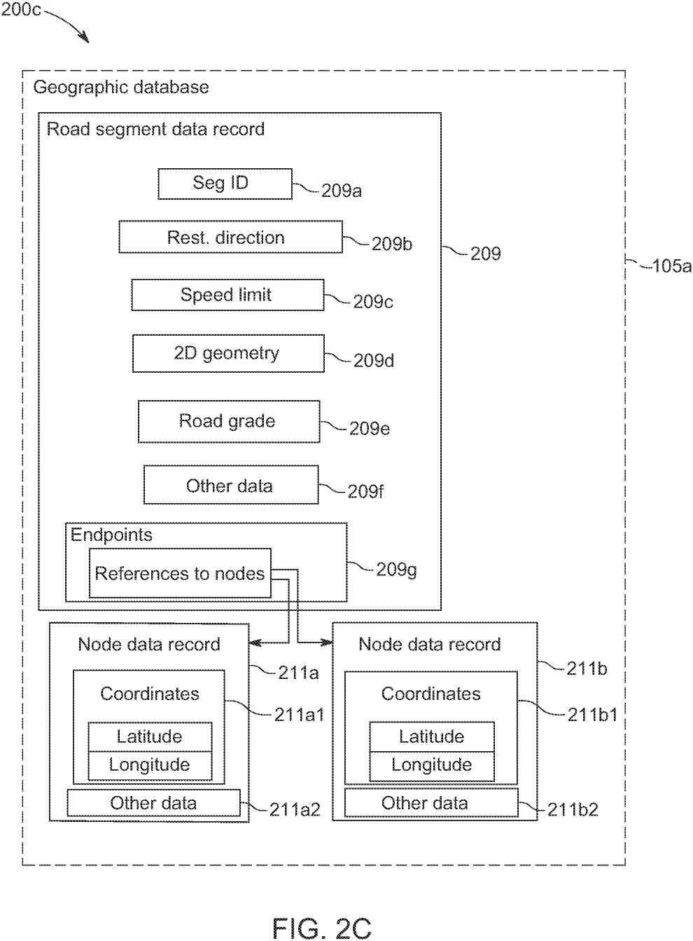

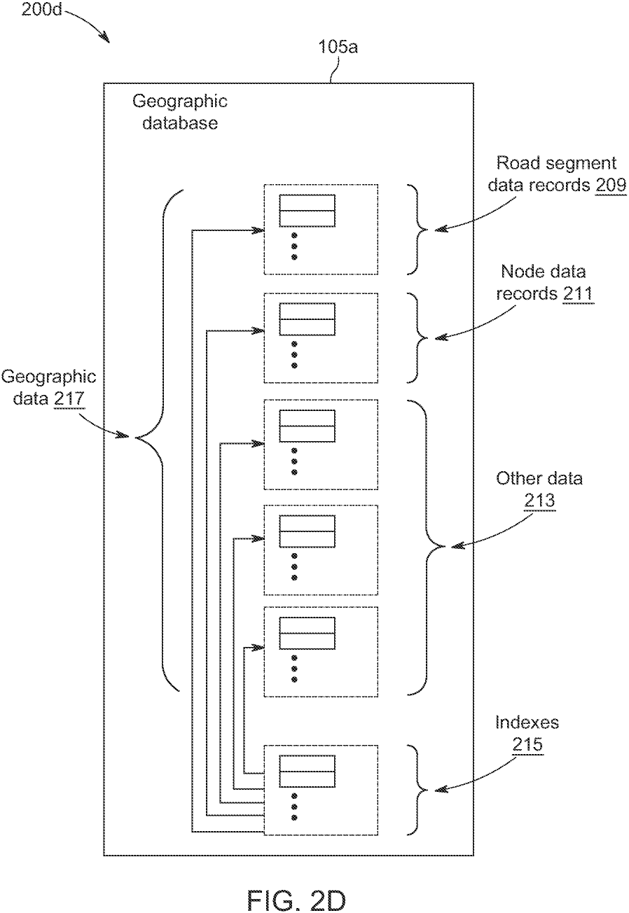

FIG. 2A is an example illustration 200a showing 200a showing different types of feature lines on a mapping interface. The illustration 200a may be associated with one or more user equipment installed in the vehicle discussed in conjunction with FIG. 1. The illustration 200a may be configured to display images about various navigation entities in the form of high-definition maps, where clarity and resolution of images are high (such as of the order of 320 dpi), and the information displayed about the navigation entities on the maps is collected using data sources beyond the on-board vehicle sensors only, to provide most accurate, up-to-date, and real-time map data. The accuracy of data is important, especially for maneuvering and control of autonomous vehicles. However, as depicted in the illustration 200a, sometimes this map data may be incomplete.

For example, on the illustration 200a, two types of feature lines are depicted. Feature line 201 is having discontinuities as some parts are missing in the feature line 201, making it appear dashed, rather than in the form of a continuous line on the user interface 200a. On the other hand, feature line 203 is a complete feature line, without any discontinuities. The purpose of the methods and systems (such as the system 101) disclosed herein, is to complete the missing parts of incomplete feature lines, like the feature line 201, and generate a new feature line that is complete and thus can be used for accurate navigation, especially e.g., for local road(s) in rural area(s).

As already discussed, the feature lines, such as the feature line 201 and the feature line 203, may be associated with lane marking data stored in the map database 105a. Thus, when the incomplete feature line 201 is generated by forming a connecting line between discontinuous parts to give a complete feature line, the system 101 is also configured to update the map database 105a based on the generated connecting line of the feature line 201. This ensures that the map data stored in the map database 105a is highly accurate and up to date. In some embodiments, the feature lines are associated with corresponding links, and data about the feature lines are stored in the form of link data records in the map database 105a.

FIG. 2B is an example illustration that shows format of the map data 200b stored in the map database 105a according to one or more example embodiments. FIG. 2B shows a link data record 205 that may be used to store data about one or more of the feature lines, that is the feature line 201 and the feature line 203, illustrated in FIG. 2A. This link data record 205 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 205 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along with a link between its endpoints. To represent the shape of other-than-straight roads, the mapping platform 105 and its associated map database developer select one or more shape points along the other-than-straight road portion. Shape point data included in the link data record 205 indicate the position, (e.g., latitude, longitude, and optionally, altitude or elevation) of the selected shape points along with the represented link.

Additionally, in the compiled geographic database, such as a copy of the map database 105a that is compiled and provided to the illustration 200a, there may also be a node data record 207 for each node. The node data record 207 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate the performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows an example illustration that shows another format of the map data 200c stored in the map database 105a according to one or more example embodiments. In the FIG. 2C, the map data 200c is stored by specifying a road segment data record 209. The road segment data record 209 is configured to represent data that represents a road network. In FIG. 2C, the map database 105a contains at least one road segment data record 209 (also referred to as “entity” or “entry”) for each road segment in a geographic region, such as the region shown by illustration 200a having feature lines 201 and 203, in FIG. 2A.

The map database 105a represents the geographic region of FIG. 2A also includes a database record 211 (a node data record 211a and a node data record 211b) (or “entity” or “entry”) for each node associated with the at least one road segment shown by the road segment data record 209. (The terms “nodes” and “segments” represent only one terminology for describing these physical geographic features and other terminology for describing these features is intended to be encompassed within the scope of these concepts). Each of the node data records 211a and 211b may have associated information (such as “attributes”, “fields”, etc.) that allows identification of the road segment(s) that connect to it and/or its geographic position (e.g., its latitude and longitude coordinates).

FIG. 2C is an example illustration that shows some of the components of the road segment data record 209 contained in the map database 105a. The road segment data record 209 includes a segment ID 209a by which the data record can be identified in the map database 105a. Each road segment data record 209 has associated with it information (such as “attributes”, “fields”, etc.) that describes features of the represented road segment. The road segment data record 209 may include data 209b that indicate the restrictions, if any, on the direction of vehicular travel permitted on the represented road segment. The road segment data record 209 includes data 209c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 209 may also include data 209d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segments is with mathematical expressions, such as polynomial splines.

The road segment data record 209 also includes road grade data 209e that indicates the grade or slope of the road segment. In one embodiment, the road grade data 209e include road grade change points and a corresponding percentage of grade change. Additionally, the road grade data 209e may include the corresponding percentage of grade change for both directions of a bidirectional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and the percentage of grade change indicates a percentage increase or decrease of the grade or slope. Each road segment may have several grade change points depending on the geometry of the road segment. In another embodiment, the road grade data 209e includes the road grade change points and an actual road grade value for the portion of the road segment after the road grade change point until the next road grade change point or end node. In a further embodiment, the road grade data 209e includes elevation data at the road grade change points and nodes. In an alternative embodiment, the road grade data 209e is an elevation model which may be used to determine the slope of the road segment.

The road segment data record 209 also includes data 209g providing the geographic coordinates (e.g., the latitude and longitude) of the end points of the represented road segment. In one embodiment, the data 209g are references to the node data records 209 that represent the nodes corresponding to the end points of the represented road segment.

The road segment data record 209 may also include or be associated with other data 209f that refer to various other attributes of the represented road segment. The various attributes associated with a road segment may be included in a single road segment record or may be included in more than one type of record which cross-reference each other. For example, the road segment data record 209 may include data identifying the name or names by which the represented road segment is known, the street address ranges along the represented road segment, and so on.

FIG. 2C also shows an example illustration of some of the components of the node data record 211 contained in the map database 105a. Each of the node data records 211 may have associated information (such as “attributes”, “fields”, etc.) that allows identification of the road segment(s) that connect to it and/or its geographic position (e.g., its latitude and longitude coordinates). For the embodiment shown in FIG. 2C, the node data records 211a and 211b include the latitude and longitude coordinates 211a1 and 211b1 for their nodes. The node data records 211a and 211b may also include other data 211a2 and 211b2 that refer to various other attributes of the nodes. In some embodiments, the node data records 211a and 211b may be associated with at least one first point and at least one-second point, which may be border points of a feature line to be generated (such as the line 201 depicted in FIG. 2A) and at least one-second line in the vicinity of the feature line (or at least one first point) respectively.

Thus, the overall data stored in the map database 105a may be organized in the form of different layers for greater detail, clarity, and precision. Specifically, in the case of high-definition maps, the map data may be organized, stored, sorted, and accessed in the form of three or more layers. These layers may include the road level layer, lane level layer, and localization layer. The data is stored in the map database 105a in the formats shown in FIGS. 2B and 2C may be combined in a suitable manner to provide these three or more layers of information. In some embodiments, there may be a lesser or fewer number of layers of data also possible, without deviating from the scope of the present disclosure.

FIG. 2D illustrates a block diagram 200d of the map database 105a storing map data or geographic data 217 in the form of road segments/links, nodes, and one or more associated attributes as discussed above. Furthermore, attributes may refer to features or data layers associated with the link-node database, such as an HD lane data layer.

In addition, the map data 217 may also include other kinds of data 213. The other kinds of data 213 may represent other kinds of geographic features or anything else. The other kinds of data may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 105a also includes indexes 215. The indexes 215 may include various types of indexes that relate the different types of data to each other or that relate to other aspects of the data contained in the geographic database 105a.

The data stored in the map database 105a in the various formats discussed above may help in providing precise data for high-definition mapping applications, autonomous vehicle navigation and guidance, cruise control using ADAS, direction control using accurate vehicle maneuvering, and other such services. In some embodiments, the system 101 accesses the map database 105a storing data in the form of various layers and formats depicted in FIGS. 2B-2D, to generate a feature line having missing parts.

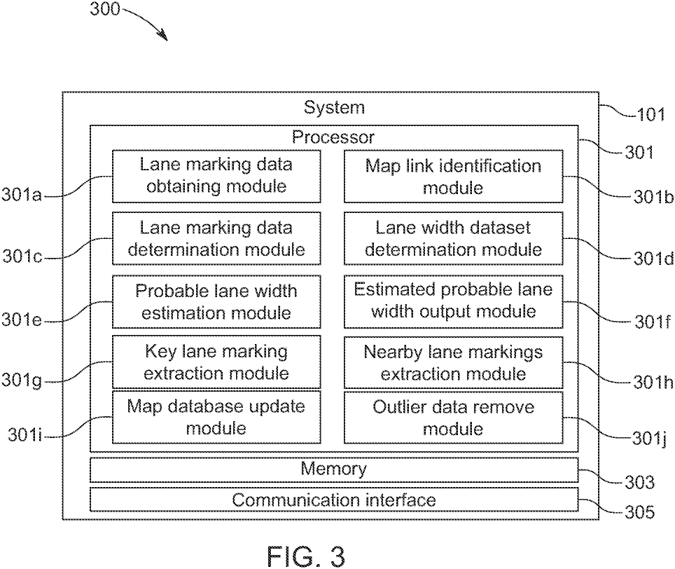

FIG. 3 is an example illustration showing a block diagram 300 of the system 101 for determining lane width data, in accordance with one or more example embodiments. The system 101 may include at least one processor 301, a memory 303, and at least one communication interface 305. The at least one processor 301 may comprise one or more of the following: a lane marking data obtaining module 301a, a map link identification module 301b, a lane marking data determination module 301c, a lane width dataset determination module 301d, a probable lane width estimation module 301e, an estimated probable lane width output module 301f, a key lane marking extraction module 301g, a nearby lane markings extraction module 301h, a map database update module 301i, and/or an outlier data remove module 301j. Of course, one or more of these modules could be removed and/or one or more other modules could be added as applicable without departing from the scope of the present disclosure.

The lane marking data obtaining module 301a may be configured to obtain lane marking data using one or more sensors. According to an embodiment herein, the one or more sensors obtain image information regarding the lane markings present or absent on the road. Here, the sensors may be a camera, or the like including an image sensor and may be provided at a position where it is capable of capturing images of the lane markings present on the road. As such one or more sensors, a rear camera or the like may be suitably used.

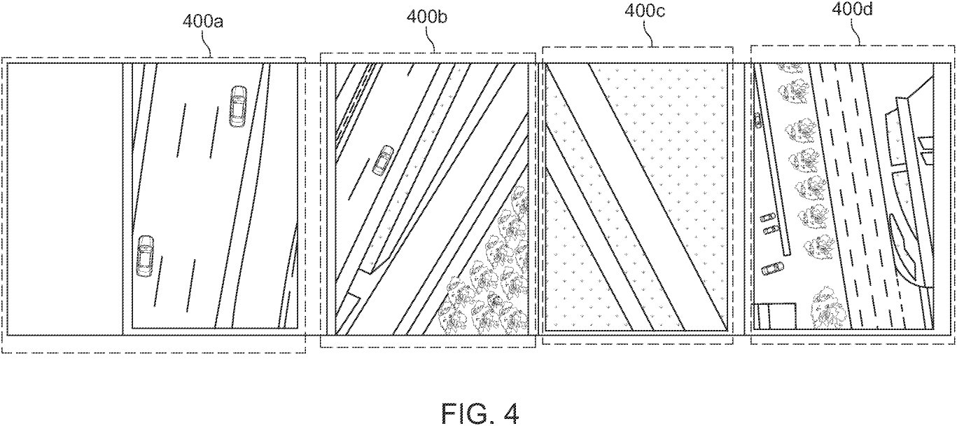

The map link identification module 301b may be configured to identify at least one map link or topology associated with the obtained lane marking data based on map data representative of one or more map links or topologies. The map link identification module 301b and its associated functionality will be discussed in conjunction with the description of FIG. 4 provided herein.

FIG. 4 illustrates a diagrammatic representation showing a single-digitized multi-lane road 400a, a single-digitized one-lane road 400b, a multi-digitized road with one lane in each direction 400c, and a multi-digitized road with more than two plus lanes in either direction 400d, in accordance with one or more example embodiments. Thus, after associating with the map data, all lane marking data may be categorized based on their associated map links as shown in Table 1.

In the single-digitized multi-lane road 400a category, a map link geometry represents a one-directional road, and the road has multiple lanes such as freeway, arterial, and collector. Further, in the single-digitized one-lane road 400b category, the map link geometry represents a one-directional road, and the road has one lane only such as a ramp. Furthermore, in the multi-digitized road with one lane in each direction 400c category, the map link geometry represents a two-directional road, and each directional road has one lane only such as a local road in the rural area. Lastly, in the multi-digitized road with more than two plus lanes in either direction 400d category, the map link geometry represents a two-directional road, and each directional road may have more than one lane such as a collector. Only lane marking data on the multi-digitized road with one lane in each direction 400c should be extracted as they will have the problem of lane marking absence.

TABLE 1

| Associated map link category | Category 1: Single-Digitized multi-lane road | Category 2: Single-Digitized one-lane road | Category 3: Multi- Digitized Road with 1 lane in each direction | Category 4: Multi- Digitized Road with 2+ lanes in either direction |
|---|---|---|---|---|
| Detail | e) Map link geometry represents a 1- directional road. | e) Map link geometry represents a 1- directional road. | e) Map link geometry represents a 2- directional road. | e) Map link geometry represents a 2- directional road. |
| | 2) The road has multiple lanes | 2) The road has one lane only | 2) Each directional road has one lane only. | 2) Each directional road may have more than one lane. |
| Example | e.g., Freeway, Arterial Collector | e.g., Ramp | e.g., a local road in the rural area | e.g., Collector |

The lane marking data determination module 301c may be configured to determine that the obtained lane marking data is associated with a particular road type based on the identified map link or topology. In an embodiment, the particular road type corresponds to a local road. In an embodiment, the particular road type corresponds to a two-lane road having one lane respectively for each direction of travel.

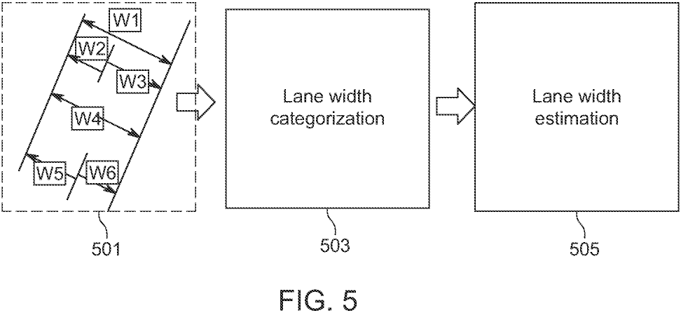

In response to determining that the obtained lane marking data is associated with the particular road type, the lane width dataset determination module 301d may be configured to determine (i) a first lane width dataset based on a first subset of the obtained lane marking data that is associated with one or more widths of a first category, and (ii) a second lane width dataset based on a second subset of the obtained lane marking data that is associated with one or more widths of a second category. The lane width dataset determination module 301d and its associated functionality will be discussed in conjunction with the description of FIG. 5 provided herein.

FIG. 5 is an example illustration showing a block diagram of a method for lane width categorization and estimation, in accordance with one or more example embodiments. For lane markings associated with the multi-digitized road with one lane in each direction, the present system follows three steps to categorize and estimate the probable lane width. Firstly, at block 501, one or more lane width candidates (W1, W2, W3, W4, W5, and W6) are identified. Secondly, at block 503, lane width is categorized based on the first category and the second category. In an embodiment, the first category (W1, W4) corresponds to widths that are greater than a threshold width, and wherein the second category (W2, W3, W5, W6) corresponds to widths that are at or lower than the threshold width. In an embodiment, the first category corresponds to lane markings that respectively define distances between road edges, and wherein the second category corresponds to lane markings that respectively define distances between a road edge and a road centerline. In an embodiment, the threshold width may be about four meters. According to an embodiment herein, half values of lane width candidates in the first category and whole values of lane width in the second category are used to estimate the lane width of the topology. Further, the weighted median value of all lane width candidates is calculated as the most probable lane width. The weight is the length of the lane marking.

Thus, the probable lane width estimation module 301e may be configured to estimate a probable lane width as a function of the first lane width dataset and the second lane width dataset. In an embodiment, the function comprises a weighted median associated with the first lane width dataset and the second lane width dataset, wherein a weight of each of the first lane width dataset and the second lane width dataset is associated with a length of the corresponding lane marking data.

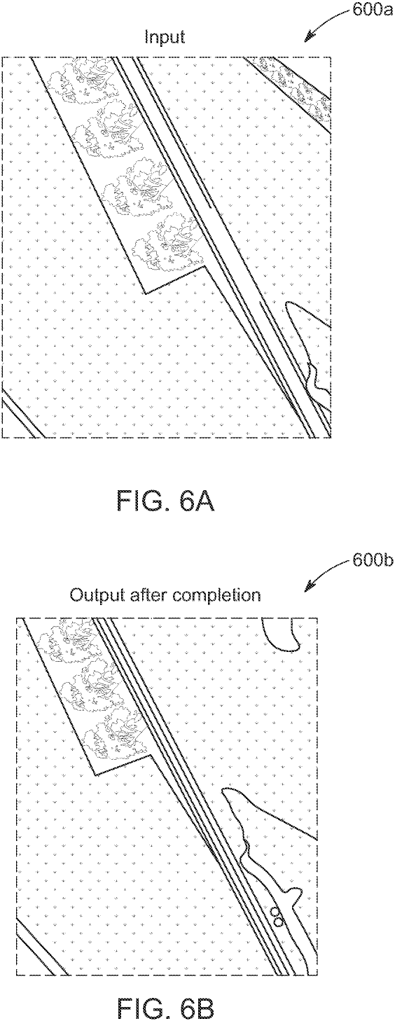

The estimated probable lane width output module 301f may be configured to output the estimated probable lane width as lane width data. Further, the key lane marking extraction module 301g may be configured to extract a key lane marking from the lane marking data based on a width of the key lane marking, such that the width of key lane marking is closest to the lane width data among all lane markings in the lane marking data. The key lane marking extraction module 301g and its associated functionality will be discussed in conjunction with the description of FIGS. 6A-6B is provided herein. FIG. 6A illustrates an example illustration showing input image 600a of the road before extraction of the key lane marking from the lane marking data, in accordance with one or more example embodiments. FIG. 6B illustrates an example diagram showing output image 600b of the road after extraction of the key lane marking from the lane marking data based on a width of the key lane marking, in accordance with one or more example embodiments. In order to complement the missing lane markings based on the probable lane width, a key lane marking may be extracted whose lane marking value is closest to the probable lane width. The nearby lane markings extraction module 301h may be configured to extract one or more nearby lane markings in the vicinity of the key lane marking. Thus, the nearby lane markings are further extracted based on the key lane marking and probable lane width.

The map database update module 301i may be configured to update a map database based on the key lane marking and the one or more nearby lane markings, such that the update comprises complementing missing lane boundary data of the obtained lane marking data.

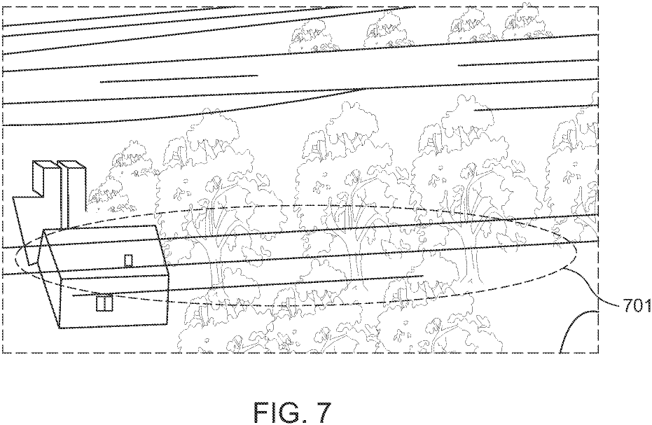

The outlier data remove module 301j may be configured to remove outlier data from the lane marking data based on a distance associated with the lane marking data and the corresponding identified map link or topology. The outlier data remove module 301j and its associated functionality will be discussed in conjunction with the description of FIG. 7 provided herein.

FIG. 7 shows an example illustration showing removal of outlier data 701 from the lane marking data based on a distance associated with the lane marking data and the corresponding identified map link or topology, in accordance with one or more examples embodiments. In an implementation, map data is integrated, and outlier data is removed by point-based or path-based map-matcher. Lane marking data may be map-matched on the map link or topology. Lane markings located on the edge of the road may have a large, signed distance to the matched link while those located near the center of the road may have a smaller signed distance. Besides, there are also outliers 701 which are located far from the corresponding map link or topology. Some lane marking data should be removed if their signed distance to the map link is larger than a value defined by the equation (1) below:

lane count* lane width ∗ 0.5 + buffer - Equation (1)

Here, lane width is set to be the largest possible lane width value (e.g., 4 m). Further, the buffer is to counter the effects of GPS fluctuations and underlying lateral offset of the map link to the real road center. The buffer is set to be about 8 m as a start.

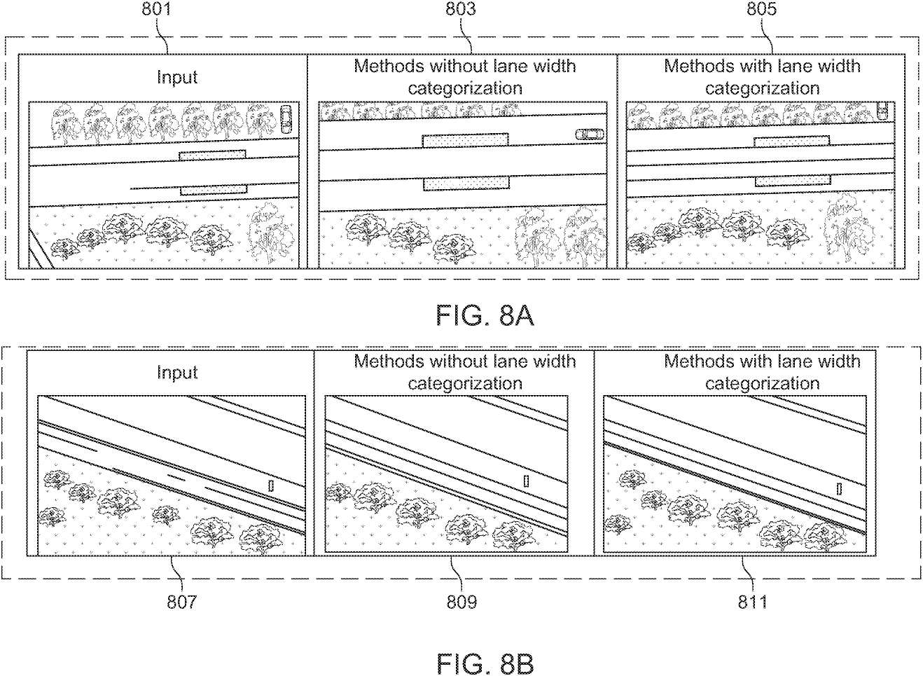

FIG. 8A illustrates an example illustration showing determining of lane width data without using lane width categorization and with using lane width categorization when there is no painted lane marking on the road center, in accordance with one or more example embodiments. A first input image 801 is of a road where painted lane markings are absent on the road center. Then, an inaccurate lane marking will be estimated by the systems which do not use the lane width categorization method, as shown in block 803. In order to estimate the correct lane marking and determine the accurate lane width data, the systems have to use lane width categorization disclosed in the present specification, as shown in block 805.

FIG. 8B shows an example illustration showing determining of lane width data without using lane width categorization and with using lane width categorization when there is painted lane marking on the road center, in accordance with one or more example embodiments. A second input image 807 is of a road where painted lane markings are present on the road center. Then, an inaccurate lane marking will be estimated by the systems which do not use the lane width categorization method, as shown in block 809. In order to estimate the correct lane marking and determine the accurate lane width data, the systems have to use lane width categorization disclosed in the present specification, as shown in block 811. Thus, the present system provides mechanisms to estimate the lane width on the multi-digitized road with one lane in each direction. Further, the present system complements the lane boundary where there is no painted lane marking. Furthermore, the present system efficiently functions when there are painted lane markings on the road center as well as when there are no painted lanes markings on the road center.

According to some embodiments, each of the modules 301a - 301j may be embodied in the processor 301. The processor 301 may retrieve computer program code instructions that may be stored in the memory 303 for the execution of computer program code instructions, which may be configured for determining the driving direction.

The processor 301 may be embodied in a number of different ways. For example, the processor 301 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the processor 301 may include one or more processing cores configured to perform independently. A multi-core processor may enable multiprocessing within a single physical package. Additionally, or alternatively, the processor 301 may include one or more processors configured in tandem via the bus to enable independent execution of instructions, pipelining, and/or multithreading.

Additionally, or alternatively, the processor 301 may include one or more processors capable of processing large volumes of workloads and operations to provide support for big data analysis. In an example embodiment, the processor 301 may be in communication with the memory 303 via a bus for passing information to mapping platform 105. The memory 303 may be non-transitory and may include, for example, one or more volatile and/or non-volatile memories. In other words, for example, the memory 303 may be an electronic storage device (for example, a computer-readable storage medium) comprising gates configured to store data (for example, bits) that may be retrievable by a machine (for example, a computing device like the processor 301). The memory 303 may be configured to store information, data, content, applications, instructions, or the like, for enabling the system 101 to carry out various functions in accordance with an example embodiment of the present invention. For example, the memory 303 may be configured to buffer input data for processing by the processor 301. As exemplarily illustrated in FIG. 3, the memory 303 may be configured to store instructions for execution by the processor 301. As such, whether configured by hardware or software methods, or by a combination thereof, the processor 301 may represent an entity (for example, physically embodied in circuitry) capable of performing operations according to an embodiment of the present invention while configured accordingly. Thus, for example, when the processor 301 is embodied as an ASIC, FPGA, or the like, the processor 301 may be specifically configured hardware for conducting the operations described herein. Alternatively, as another example, when the processor 301 is embodied as an executor of software instructions, the instructions may specifically configure the processor 301 to perform the algorithms and/or operations described herein when the instructions are executed. However, in some cases, the processor 301 may be a processor-specific device (for example, a mobile terminal or a fixed computing device) configured to employ an embodiment of the present invention by further configuration of the processor 301 by instructions for performing the algorithms and/or operations described herein. The processor 301 may include, among other things, a clock, an arithmetic logic unit (ALU), and logic gates configured to support the operation of the processor 301.

In some embodiments, the processor 301 may be configured to provide Internet-of-Things (IoT) related capabilities to users of system 101, where the users may be a traveler, a driver of the vehicle, and the like. In some embodiments, the users may be or correspond to an autonomous or semi-autonomous vehicle. The IoT related capabilities may in turn be used to provide smart navigation solutions by providing real-time updates to the users to take a pro-active decision on wrong-way driving determination, speed determination, lane-level speed determination, turn-maneuvers, lane changes, overtaking, merging, and the like, big data analysis, autonomous vehicle maneuvering and control, and sensor-based data collection by using the cloud-based mapping system for providing navigation recommendation services to the users. The system 101 may be accessed using the communication interface 305. The communication interface 305 may provide an interface for accessing various features and data stored in system 101. For example, the communication interface 305 may comprise an I/O interface which may be in the form of a GUI, a touch interface, a voice-enabled interface, a keypad, and the like. For example, the communication interface 305 may be a touch-enabled interface of a navigation device installed in a vehicle, which may also display various navigation-related data to the user of the vehicle. Such navigation-related data may include information about upcoming conditions on a route, route display, alerts about vehicle speed, user assistance while wrong-way driving, and the like.

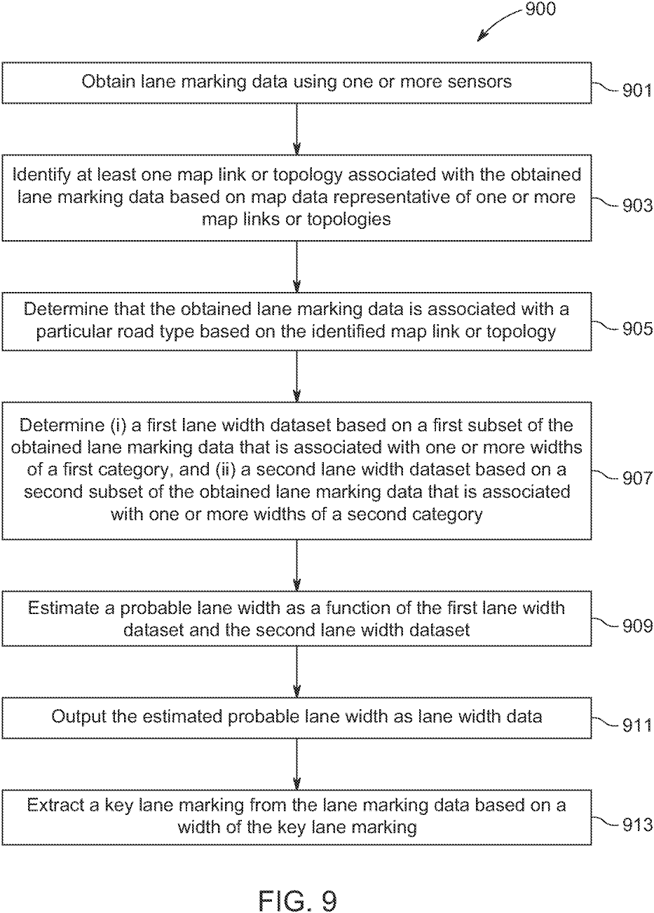

FIG. 9 is a flowchart of a method 900 for determining lane width data, in accordance with one or more example embodiments described above. The method 900 comprises, at step 901, obtaining lane marking data using one or more sensors. According to an embodiment herein, the one or more sensors obtain image information regarding the lane markings present or absent on the road. Here, the sensors may be a camera, or the like including an image sensor and may be provided at a position where it is capable of capturing images of the lane markings present on the road. As such one or more sensors, a rear camera or the like may be suitably used. The method 900 comprises, at step 903, identifying at least one map link or topology associated with the obtained lane marking data based on map data representative of one or more map links or topologies. The method 900 comprises, at step 905, determining that the obtained lane marking data is associated with a particular road type based on the identified map link or topology. In an embodiment, the particular road type corresponds to a local road. In an embodiment, the particular road type corresponds to a two-lane road having one lane respectively for each direction of travel.

In response to determining that the obtained lane marking data is associated with the particular road type, the method 900 comprises, at step 907, determining (i) a first lane width dataset based on a first subset of the obtained lane marking data that is associated with one or more widths of a first category, and (ii) a second lane width dataset based on a second subset of the obtained lane marking data that is associated with one or more widths of a second category. In an embodiment, the first category corresponds to widths that are greater than a threshold width, and wherein the second category corresponds to widths that are at or lower than the threshold width. In an embodiment, the first category corresponds to lane markings that respectively define distances between road edges, and wherein the second category corresponds to lane markings that respectively define distances between a road edge and a road centreline.

Further, the method 900 comprises, at step 909, estimating a probable lane width as a function of the first lane width dataset and the second lane width dataset. In an embodiment, the function comprises a weighted median associated with the first lane width dataset and the second lane width dataset. In an embodiment, a weight of each of the first lane width dataset and the second lane width dataset is associated with a length of the corresponding lane marking data.

The method 900 comprises, at step 911, outputting the estimated probable lane width as lane width data. The method 900 comprises, at step 913, extracting a key lane marking from the lane marking data based on a width of the key lane marking, such that the width of key lane marking is closest to the lane width data among all lanes markings in the lane marking data.

It will be understood that each block of the flow diagram of the method 900 may be implemented by various means, such as hardware, firmware, processor, circuitry, and/or other communication devices associated with the execution of software including one or more computer program instructions. For example, one or more of the procedures described above may be embodied by computer program instructions. In this regard, the computer program instructions which embody the procedures described above may be stored by the memory 303 of the system 101, employing an embodiment of the present invention and executed by the processor 301. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 900 support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Further using the method described in the accompanying embodiments of the flowchart shown in FIG. 9, which implements the various functionalities of the system 101 described in FIG. 3, the accuracy of the map data may be highly improved. This is specifically advantageous in cases of map data related to lane markings, which may have discontinuities due to any of the reasons discussed previously. This is particularly useful for high-definition maps which are used for autonomous driving vehicles, as system 101 improves the quality of map data stored in map database 105a, thereby leading to more accurate, safe, and reliable decision-making for autonomous driving scenarios.

The improvement in the quality of map data by using the method 900 and system 101 disclosed herein may be used for generating mapping display on a high-definition map installed in a vehicle.

Further, using the methods and systems disclosed herein, the vehicle associated with the with the high-definition map, such as an autonomous vehicle (that is capable of sensing its environment and operating without human involvement), is able to achieve better safety and reliability of navigation for better manoeuvring and control of the autonomous vehicle.

Additionally, the vehicle may include a motor vehicle, a non-motor vehicle, an automobile, a car, a scooter, a truck, a van, a bus, a motorcycle, a bicycle, a Segway, and/or the like. The vehicle may be a semi-autonomous vehicle or even a manual vehicle. In various embodiments, the vehicle may be equipped with various sensors for generating or collecting sensor data. For instance, the sensors of the vehicle 301 may include a radar system, a LiDAR system, a global positioning sensor for gathering location data (e.g., GPS coordinates), temporal information sensors, orientation sensors augmented with height sensors, tilt sensors, image sensors, and the like. In some example embodiments, the sensor data may be generated and reported to system 101, at a predefined frequency. For instance, the predefined frequency may be as high as one hertz, based on the capabilities of the sensors. In any which way, the vehicle may be able to gain the advantage of system 101 and method 900, irrespective of the type of the vehicle.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system comprising:
a memory configured to store computer-executable instructions; and
at least one processor configured to execute the computer-executable instructions to:
obtain lane marking data using one or more sensors;
based on map data representative of one or more map links or topologies, identify
at least one map link or topology associated with the obtained lane marking data;
based on the identified map link or topology, determine that the obtained lane marking data is associated with a particular road type;
in response to determining that the obtained lane marking data is associated with the particular road type, determine (i) a first lane width dataset based on a first subset of the obtained lane marking data that is associated with one or more widths of a first category, and (ii) a second lane width dataset based on a second subset of the obtained lane marking data that is associated with one or more widths of a second category;
estimate a probable lane width as a function of the first lane width dataset and the second lane width dataset; and
output the estimated probable lane width as lane width data.

2. The system of claim 1, wherein the particular road type corresponds to a local road.

3. The system of claim 1, wherein the particular road type corresponds to a two-lane road having one lane respectively for each direction of travel.

4. The system of claim 1, wherein the first category corresponds to widths that are greater than a threshold width, and wherein the second category corresponds to widths that are at or lower than the threshold width.

5. The system of claim 1, wherein the first category corresponds to lane markings that respectively define distances between road edges, and wherein the second category corresponds to lane markings that respectively define distances between a road edge and a road centerline.

6. The system of claim 1, wherein the function comprises a weighted median associated with the first lane width dataset and the second lane width dataset.

7. The system of claim 6, wherein a weight of each of the first lane width dataset and the second lane width dataset is associated with a respective length of a corresponding lane marking represented by the lane marking data.

8. The system of claim 1, wherein the at least one processor is further configured to extract a key lane marking from the lane marking data based on a width of the key lane marking, such that the width of key lane marking is closest to the estimated probable lane width among all lane markings in the lane marking data.

9. The system of claim 8, wherein the at least one processor is further configured to extract one or more nearby lane markings in vicinity of the key lane marking.

10. The system of claim 9, wherein the at least one processor is further configured to update a map database based on the key lane marking and the one or more nearby lane markings, such that the update comprises complementing missing lane boundary data of the obtained lane marking data.

11. The system of claim 1, wherein the at least one processor is further configured to: remove outlier data from the lane marking data based on a distance associated with the lane marking data and the corresponding identified map link or topology.

12. A method comprising:
obtaining lane marking data using one or more sensors;
based on map data representative of one or more map links or topologies, identifying at least one map link or topology associated with the obtained lane marking data;
based on the identified map link or topology, determining that the obtained lane marking data is associated with a particular road type;
in response to determining that the obtained lane marking data is associated with the particular road type, determining (i) a first lane width dataset based on a first subset of the obtained lane marking data that is associated with one or more widths of a first category, and (ii) a second lane width dataset based on a second subset of the obtained lane marking data that is associated with one or more widths of a second category;
estimating a probable lane width as a function of the first lane width dataset and the second lane width dataset; and
outputting the estimated probable lane width as lane width data.

13. The method of claim 12, wherein the particular road type corresponds to a local road.

14. The method of claim 12, wherein the particular road type corresponds to a two-lane road having one lane respectively for each direction of travel.

15. The method of claim 12, wherein the first category corresponds to widths that are greater than a threshold width, and wherein the second category corresponds to widths that are at or lower than the threshold width.

16. The method of claim 12, wherein the first category corresponds to lane markings that respectively define distances between road edges, and wherein the second category corresponds to lane markings that respectively define distances between a road edge and a road centerline.

17. The method of claim 12, wherein the function comprises a weighted median associated with the first lane width dataset and the second lane width dataset.

18. The method of claim 17, wherein a weight of each of the first lane width dataset and the second lane width dataset is associated with a length of the corresponding lane marking data.

19. The method of claim 12 further comprising extracting a key lane marking from the lane marking data based on a width of the key lane marking, such that the width of key lane marking is closest to the lane width data among all lane markings in the lane marking data.

20. A computer program product comprising a non-transitory computer-readable medium having stored thereon computer-executable instructions which when executed by at least one processor, cause the at least one processor to carry out operations for determining lane width data, the operations comprising:
obtaining lane marking data using one or more sensors;
based on map data representative of one or more map links or topologies, identifying at least one map link or topology associated with the obtained lane marking data;
based on the identified map link or topology, determining that the obtained lane marking data is associated with a particular road type;
in response to determining that the obtained lane marking data is associated with the particular road type, determining (i) a first lane width dataset based on a first subset of the obtained lane marking data that is associated with one or more widths of a first category, and (ii) a second lane width dataset based on a second subset of the obtained lane marking data that is associated with one or more widths of a second category;
estimating a probable lane width as a function of the first lane width dataset and the second lane width dataset; and
outputting the estimated probable lane width as lane width data.
